(19) United States
(12) Patent Application Publication
(10) Pub. No.: US 2005/0076168 A1
(43) Pub. Date: Apr. 7, 2005

(54) Logical devices as a wrapper for physical devices in a system

(75) Inventors: William F. McWalter, Stirling (GB); Vladimir K. Beliaev, Santa Clara, CA (US)

Correspondence Address: MARTINE PENILLA & GENCARELLA, LLP, 710 LAKEWAY DRIVE, SUITE 200, SUNNYVALE, CA, 94085, US

(73) Assignee: Sun Microsystems, Inc., Santa Clara, CA (US)

(21) Appl. No.: 10/680,735

(22) Filed: Oct. 6, 2003

(51) Int. Cl. G06F 13/12

(52) U.S. Cl. 710/72

(57) ABSTRACT

An invention is provided for abstracting physical devices in a system. The invention includes a physical device code segment capable of receiving device data from a physical device. In communication with the physical device code segment is a logical device code segment. The logical device code segment is capable of receiving the device data from the physical device code segment. An application code segment, which is capable of processing device data generated by the physical device, is in communication with the logical device code segment. In this manner, the application code segment can access the device data from the logical device code segment.

### CROSS REFERENCE TO RELATED APPLICATIONS

This application is related to U.S. patent application Ser. No. ______ (Attorney Docket No. SUNMP153), filed Oct. 6, 2003, and entitled “Using Logical Names as a String to Distinguish Logical Controls,” which is incorporated herein by reference.

### BACKGROUND OF THE INVENTION

1. Field of the Invention

This invention relates generally to software control of physical devices, and more particularly to methods for using logical devices as logical wrappers for physical devices in a system.

2. Description of the Related Art

The electronic content and sophistication of automotive designs has grown markedly. Microprocessors are prevalent in a growing array of automotive entertainment, safety, and control functions. Consequently, this electronic content is playing an increasing role in the sales and revenues of the automakers. The features provided by the electronic content include audio systems, vehicle stability control, driver activated power train controls, adaptive cruise control, route mapping, collision warning systems, security systems, etc. The significant increase of the electronic content of land based vehicles has concomitantly occurred with the explosive growth of the Internet and the associated data driven applications supplied through mobile applications.

Telematics, a broad term that refers to vehicle-based wireless communication systems and information services, promises to combine vehicle safety, entertainment, and convenience features through wireless access to distributed networks, such as the Internet. Telematics offers the promise to move away from the hardware-centric model from audio and vehicle control systems that are built into devices that are custom designed for each vehicle, to infotainment delivered by plug-and-play hardware whose functionality can be upgraded through software loads or simple module replacement. Furthermore, new revenue streams will be opened up to automobile manufacturers and service providers through the products and services made available through telematics.

However, when generating telematics software it is often necessary to include computer code that interacts with the various physical controls present in the vehicle. Unfortunately, the large number of physical controls, such as sliders, dials, keypads, buttons, etc., which are currently available in today's automobiles, gives rise to difficulties when constructing a user friendly user interface system. Moreover, new physical controls continue to be developed, which further increases the difficulty in constructing user interfaces that account for all the physical controls.

As a result, conventional application programs generally must decide ahead of time which physical controls their application program will be capable of interacting with. For example, a prior art temperature control telematics program might, for example, be developed to work with an air conditioning unit that uses a dial to increase and decrease the temperature. In this case, the application program would generally be developed with the dial interaction code, which actually interacts with the dial, hard coded into the application program. As a result, the application program cannot be utilized in an automobile using a slider control to increase and decrease the temperature.

In view of the foregoing, there is a need for techniques that provide the ability to describe the functionality of most physical devices. The techniques should allow application developers to access a plurality of different physical devices in the same or similar manner. Thus allowing the application programs to be ported to different systems having different physical controls.

### SUMMARY OF THE INVENTION

Broadly speaking, the present invention fills these needs by abstracting physical devices in a system. Embodiments of the present invention provide logical devices as wrappers for the physical devices of a system, which provide a flexible interface that affords the ability to describe the functionality of most physical devices.

In one embodiment, a computer program embodied on a computer readable medium for abstracting physical devices in a system is disclosed. The computer program includes a physical device code segment capable of receiving device data from a physical device. In communication with the physical device code segment is a logical device code segment. The logical device code segment is capable of receiving the device data from the physical device code segment. An application code segment, which is capable of processing device data generated by the physical device, is in communication with the logical device code segment. In this manner, the application code segment can access the device data from the logical device code segment. For example, the logical device code segment and physical device code segment can form a class for use with a particular physical device. The application code segment can then utilize the class to communicate with the physical device.

A method for abstracting physical devices in a system is disclosed in an additional embodiment of the present invention. The method includes receiving device data from a physical device computer code segment. The physical device computer code segment is capable of receiving the device data from the physical device. Access to the device data is then provided to an application program. In one aspect, the device data can include the current state of the physical device and event data indicating whether the current state of the physical device has changed. In one aspect, access to the device data can be provided using an application programming interface (API). For example, the API can provide access to device data from a plurality of physical devices, wherein the each? physical device provides data for the same number of variables, such as, when all the physical devices are one-dimensional controls, as described below.

In a further embodiment, a computer interface for abstracting physical devices in a system is disclosed. The computer interface includes a physical device implementation code segment capable of receiving device data from a physical device, and an API code segment in communication with a physical device implementation code segment. The API code segment is capable of receiving the device data from the physical device code segment. In operation, an application program can communicate with the API code segment to access the device data. As above, the API code segment can provide access to device data from a plurality of physical devices, wherein the each physical device provides data for the same number of variables. Moreover, the application program can access device data from different physical devices without altering the application program when the physical devices provide data for the same number of variables. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is an illustration showing a plurality of exemplary one-dimensional physical controls that can be present in an automobile or other system;

FIG. 2 is an illustration showing a plurality of exemplary two-dimensional physical controls that can be present in a system;

FIG. 3 is a block diagram showing logical device usage, in accordance with an embodiment of the present invention;

FIG. 4A is a block diagram showing a one-dimensional logical device utilized to communicate with a one-dimensional slider control, in accordance with an embodiment of the present invention;

FIG. 4B is a block diagram showing the one-dimensional logical device utilized to communicate with a one-dimensional dial control, in accordance with an embodiment of the present invention; and

FIG. 5 is a block diagram illustrating an exemplary one-dimensional logical device object in accordance with an embodiment of the present invention.

### DETAILED DESCRIPTION

An invention is disclosed for a method for abstracting physical devices in a system. Broadly speaking, embodiments of the present invention provide logical devices as wrappers for the physical devices of a system. The logical devices provide a flexible interface that affords the ability to describe the functionality of most physical devices. In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

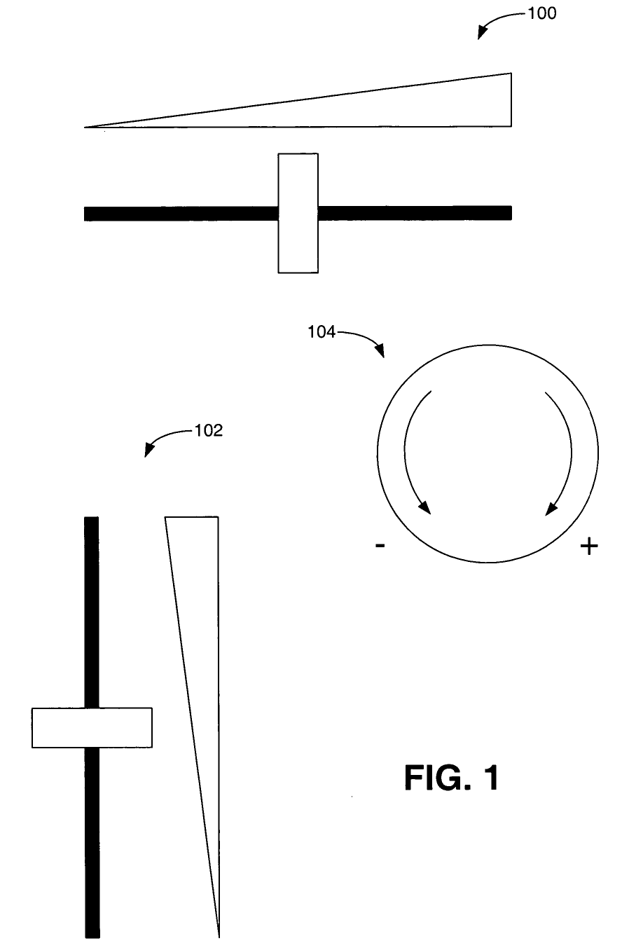

As mentioned above, embodiments of the present invention provide logical devices as abstract wrappers for the physical devices of a system. To assist in understanding the embodiments of the present invention, a discussion of control dimensionality follows. FIG. 1 is an illustration showing a plurality of exemplary one-dimensional physical controls that can be present in an automobile or other system. As will be described in greater detail subsequently, one-dimensional physical controls are physical controls that provide data for a single variable. As shown in FIG. 1, one-dimensional physical controls can include, for example, a horizontal slider 100, a vertical slider 102, a dial 104, or any other physical control that provides data for essentially a single variable. Although only sliders and dials are illustrated in FIG. 1, it should be noted that a one-dimensional control can include any type of device capable of providing data for a single variable.

As mentioned above, a one-dimensional physical control is a physical control that provides data for a single variable. For example, the horizontal slider 100 of FIG. 1 allows a user to increase the value of a variable by sliding the horizontal slider 100 to the right, and decrease the value by sliding the horizontal slider 100 to the left. In a similar manner, the vertical slider 102 allows a user to increase the value of a variable by sliding the vertical slider 102 up, and decrease the value by sliding the vertical slider 102 down. Although the motion of the dial 104 is different than that of the horizontal and vertical sliders 100 and 102, the affect on a variable is the same. That is, by rotating the dial 104 clockwise, the user can increase the value of a variable. Similarly, by rotating the dial 104 counterclockwise, the user can decrease the value of the variable. As can be appreciated, the controls illustrated in FIG. 1 allow the user to control data for a single variable.

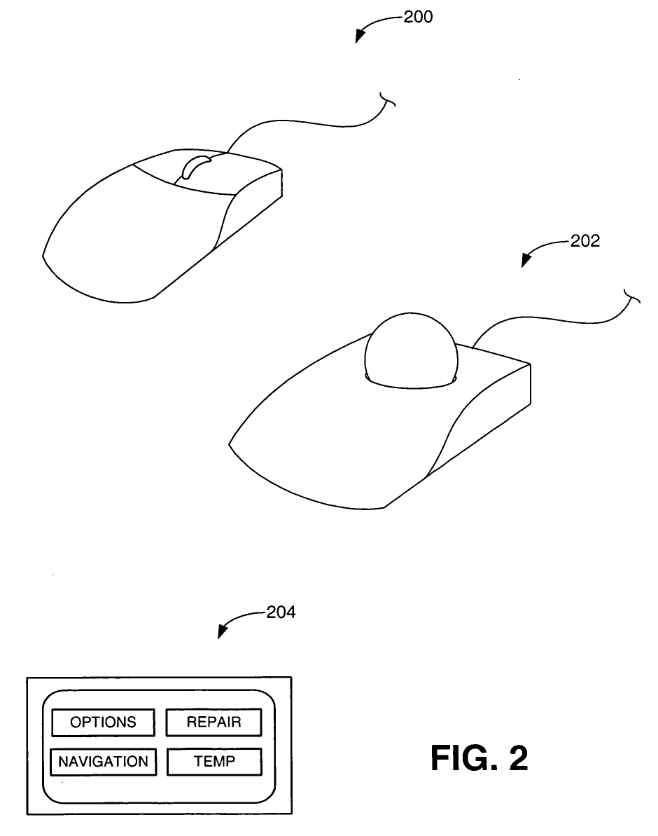

In a similar manner, two-dimensional physical controls provide data for two variables. FIG. 2 is an illustration showing a plurality of exemplary two-dimensional physical controls that can be present in a system. As will be described in greater detail subsequently, two-dimensional physical controls are physical controls that provide data for two variables. As shown in FIG. 2, two-dimensional physical controls can include, for example, a mouse 200, a trackball 202, a touch screen 204, or any other physical control that provides data for essentially two variables. As above, it should be noted that two-dimensional controls are not limited to those illustrated in FIG. 2 and can include any type of device capable of providing data for two variables. Of course, more than 2D controls are envisioned. For instance, control may includetracking x, y, and z coordinates by having a user wear gloves that include sensors, and the sensors are detected to identify the glove location to provide 3D control. In addition, however, dimensions beyond 3D may be possible with appropriate processing.

As mentioned above, two-dimensional physical controls provide data for two variables. For example, the mouse 200 provides data for a first variable when moved forward and backward. The mouse 200 also provides data for a second variable when moved right and left. Similarly, the trackball 202 provides data for a first variable when the trackball is rotated forward and backward. The trackball 202 also provides data for a second variable when the trackball is rotated right and left. Although the motions on the touch screen 204 are different than those of the mouse 200 and trackball 202, the touch screen 204 also provides data for two different variables. The touch screen 204 provides values for both variables depending on where the screen is contacted. Specifically, an x-value is provided based on the location of the contact from left to right, and a y-value based on the location of the contact from top to bottom. As can be appreciated, the controls illustrated in FIG. 2 allow the user to control data for two variables.

Embodiments of the present invention utilize the similarities of physical controls of the same dimension to provide logical devices that function as wrappers for physical controls of the same dimension. For example, a one-dimensional logical device functions as a wrapper for one-dimensional physical controls, such as sliders and dials, and a two-dimensional logical device functions as a wrapper for two-dimensional physical controls, such as trackballs and touch screens. Hence, embodiments of the present invention allow application developers to create application programs that interact with the logical devices, which interact with a plurality of similar physical devices, instead of particular physical devices. In this manner, the application program can be executed in any environment having physical controls that can interact with the logical device. For example, an application program can be created to interact with one-dimensional logical devices. Once developed, the application program can be executed with any of the physical controls illustrated in FIG. 1, and also with any other one-dimensional control that is later developed.

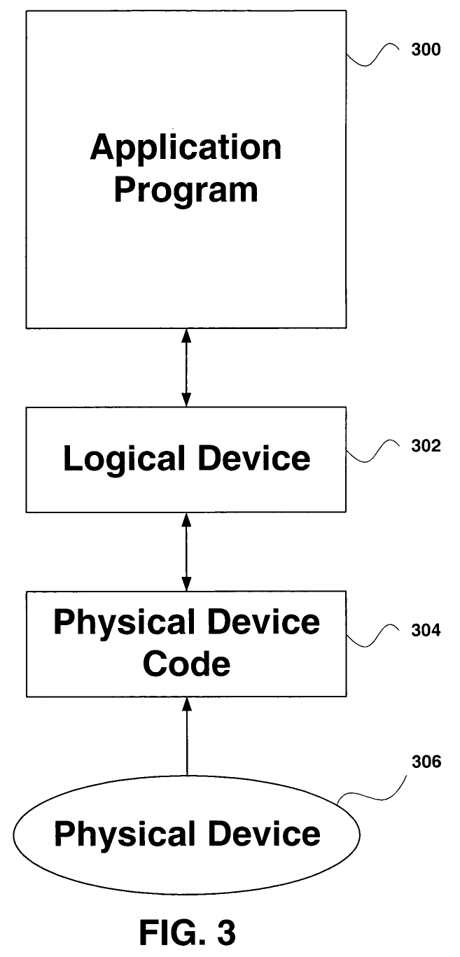

FIG. 3 is a block diagram showing logical device usage, in accordance with an embodiment of the present invention. Using the embodiments of the present invention, physical device code 304 is developed for each physical device 306. In operation, the physical device code 304 is capable of receiving device data directly from the physical device 306, and as such is developed specifically for the particular physical device 306. For example, physical device code 304 can be developed specifically for a horizontal slider. Other physical device code 304 can be developed specifically for a dial, and still further physical device code 304 can be developed specifically for a trackball.

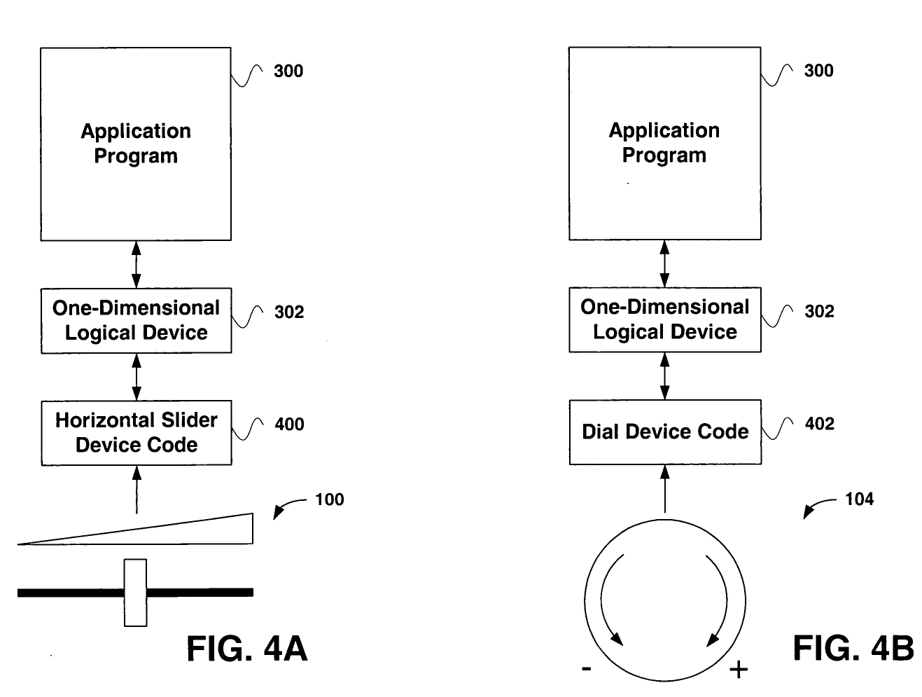

The logical device 302 provides an interface between the physical device code 304 and the application program 300. The logical device 302 allows the application program 300 to obtain the device data without requiring the application program 300 to have knowledge of the specific physical device 306 queried. For example, as described above, the logical device 302 can be a one-dimensional logical device that is capable of communicating with physical device code 304 designed for a one-dimensional physical device 306, such as a slider. In this manner, the application program 300 can advantageously communicate with the logical device 302 in substantially the same manner regardless of the particular properties of the physical device 306. As a result, great flexibility and portability can be achieved, as illustrated in next in FIGS. 4A and 4B.

FIG. 4A is a block diagram showing a one-dimensional logical device utilized to communicate with a one-dimensional slider control, in accordance with an embodiment of the present invention. In the example of FIG. 4A, the application program 300 is designed to process signals from a one-dimensional physical control. For example, the application program can control the temperature in an automobile using a temperature variable. In FIG. 4A the physical control is a horizontal slider 100. For example, the user moves the horizontal slider 100 to the left to decrease the temperature and moves the horizontal slider 100 to the right to increase the temperature.

The device data from the horizontal slider 100 is read using the horizontal slider device code 400, which is the physical device code designed specifically for the horizontal slider 100. For example, the device data can indicate whether the temperature should be increased or decreased, and by how many degrees the change should be. Once the horizontal slider device code 400 obtains the device data from the horizontal slider 100, the device data is provided to the one-dimensional logical device 302.

The application program 300 can then obtain the device data from the one-dimensional logical device 302 when needed. The interfaces for the one-dimensional logical device 302 are also known to the application program 300. However, the application program 300 does not have to be aware of what type of one-dimensional device is being utilized. For example, when the application program 300 is a temperature control program for an automobile, the application program 300 typically only requires device data indicating whether the temperature should be increased or decreased, and by how many degrees the change should be. This device data can be obtained from the one-dimensional logical device 302. In this manner, the application program 300 can be executed in any environment having a one-dimensional control for temperature control, as illustrated next with reference to FIG. 4B.

FIG. 4B is a block diagram showing the one-dimensional logical device utilized to communicate with a one-dimensional dial control, in accordance with an embodiment of the present invention. In the example of FIG. 4B, the application program 300 can be, for example, the same application program 300 illustrated in FIG. 4A, which was designed to control the temperature in an automobile using a temperature variable. In FIG. 4B the physical control is a dial 104. For example, the user rotates the dial 104 to the left to decrease the temperature and rotates the dial 104 to the right to increase the temperature.

Similar to above, the device data from the dial 104 is read using the dial device code 402, which is the physical device code designed specifically for the dial 104. For example, as with the slider, the device data can indicate whether the temperature should be increased or decreased, and by how many degrees the change should be. Once dial device code 402 obtains device data for the dial 104, the device data is provided to the one-dimensional logical device 302.

The application program 300 can then obtain the device data from the one-dimensional logical device 302 when needed. As can be appreciated, the same device data can be obtained from the dial and slider. Thus, the application program 300 can obtain device data indicating whether the temperature should be increased or decreased, and by how many degrees the change should be from the one-dimensional logical device 302 using the same program calls used in FIG. 4A.

In one embodiment, the logical devices form an application programming interface (API) for use in the Java programming language. Unlike most programming languages, in which a program is compiled into machine-dependent, executable program code, Java classes are compiled into machine independent bytecode class files which are executed by a machine-dependent virtual machine. The virtual machine provides a level of abstraction between the machine independence of the bytecode classes and the machine-dependent instruction set of the underlying computer hardware. A class loader is responsible for loading the bytecode class files as needed, and an interpreter or just-in-time compiler provides for the transformation of bytecodes into machine code.

More specifically, Java is a programming language designed to generate applications that can run on all hardware platforms, small, medium and large, without modification. Developed by Sun, Java has been promoted and geared heavily for the Web, both for public Web sites and intranets. Java is an interpreted language. As mentioned above, the source code of a Java program is compiled into an intermediate language called bytecode. The bytecode is then converted (interpreted) into machine code at runtime. Java platforms execute Java applications by invoking a Java interpreter (Java Virtual Machine), which translates the bytecode into machine code and runs it. Thus, Java application programs are not dependent on any specific hardware and will run in any computer with the Java Virtual Machine software.

When embodied as an API, the logical device API forms a language and message format that can be used by the application program to communicate with the physical devices of the system. The logical device API can be implemented by writing physical device specific methods for each method provided in the logical device API, which provide the linkage to the required subroutine for execution. These method calls form the physical device code for the system. Thus, a logical device API indicates which method calls are available to the application program. Thereafter, each logical device can be instantiated as a separate object for each physical control.

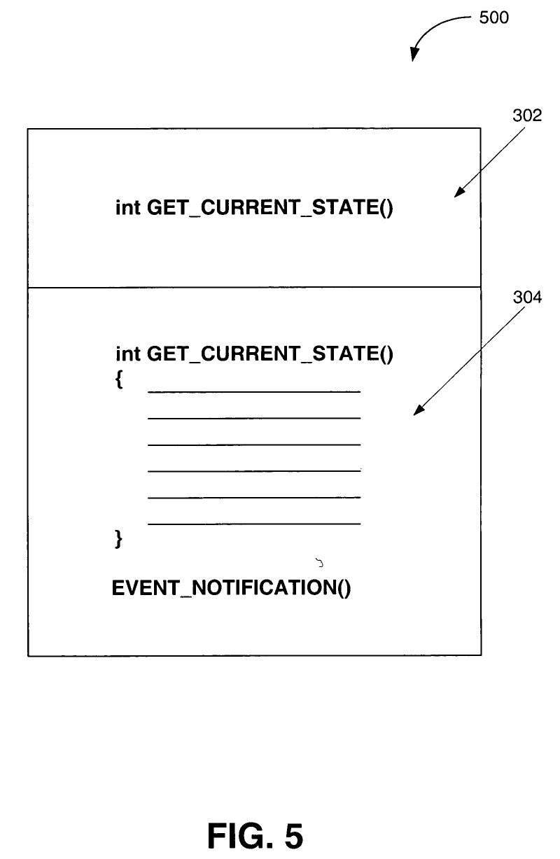

FIG. 5 is a block diagram illustrating an exemplary one-dimensional logical device object 500 in accordance with an embodiment of the present invention. As illustrated in FIG. 5, the exemplary one-dimensional logical device object 500 comprises a method GET_CURRENT_STATE( ), which provides the current state of the particular physical control represented by the one-dimensional logical device object 500. For example, the application program can call the method GET_CURRENT_STATE( ) to obtain the device data for the physical control. To continue the above temperature control example, the application can call the method GET_CURRENT_STATE( ) to obtain device data indicating whether the temperature should be increased or decreased, and by how many degrees the change should be. In the example of FIG. 5, the interface to the method GET_CURRENT_STATE( ) corresponds to the logical device 302 of FIG. 3.

The actual code for the method GET_CURRENT_STATE ( ) forms the physical device code 304 of FIG. 3. That is, a developer who is aware of the physical properties and specific interfaces of the particular physical device writes the actual computer instructions that comprise the method GET_CURRENT_STATE( ). However, the developer should ensure that the method is called and returns the data listed in the logical device 302. For example, in FIG. 5 the developer of the physical device code should ensure that the method is called as GET_CURRENT_STATE( ) and returns an integer value indicating the current setting of the physical device. In this manner, the application program does not need to know the specifics of the physical device queried. That is, the application program can call GET_CURRENT_STATE( ) and can expect to receive an integer value indicating the current setting of the physical device, regardless of whether the device is a slider, dial, or any other one-dimensional physical device.

Another exemplary method that can be present in the one-dimensional object 500 is the method EVENT_NOTIFICATION( ). This method can, for example, be utilized to notify the application program that the current state of the physical device has changed. In this case, the application program can take appropriate action, such as calling the GET_CURRENT_STATE( ) method to obtain the current setting of the physical device. Although the forgoing has been described in terms of the methods GET_CURRENT_STATE( ) and EVENT_NOTIFICATION( ) it should be noted that any methods and data can be utilized to define a logical device class.

Although the present invention is described based on the Java programming language, other programming languages may be used to implement the embodiments of the present invention, such as other object oriented programming languages. Object-oriented programming is a method of creating computer programs by combining certain fundamental building blocks, and creating relationships among and between the building blocks. The building blocks in object-oriented programming systems are called “objects.”

An object is a programming unit that groups together a data structure (variables or fields) and the operations (methods) that can use or affect that data. Thus, an object consists of data and one or more operations or procedures that can be performed on that data. The joining of data and operations into a unitary building block is called “encapsulation.”

An object can be instructed to perform one of its methods when it receives a “message.” A message is a command or instruction to the object to execute a certain method. It consists of a method selection (name) and a plurality of arguments that are sent to an object. A message tells the receiving object what operations to perform.

One advantage of object-oriented programming is the way in which methods are invoked. When a message is sent to an object, it is not necessary for the message to instruct the object how to perform a certain method. It is only necessary to request that the object execute the method. This greatly simplifies program development.

Object-oriented programming languages are predominantly based on a “class” scheme. A class defines a type of object that typically includes both variables and methods for the class. An object class is used to create a particular instance of an object. An instance of an object class includes the variables and methods defined for the class. Multiple instances of the same class can be created from an object class. Each instance that is created from the object class is said to be of the same type or class.

A hierarchy of classes can be defined such that an object class definition has one or more subclasses. A subclass inherits its parent's (and grandparent's etc.) definition. Each subclass in the hierarchy may add to or modify the behavior specified by its parent class.

To illustrate, an employee object class can include “name” and “salary” variables and a “set_salary” method. Instances of the employee object class can be created, or instantiated for each employee in an organization. Each object instance is said to be of type “employee.” Each employee object instance includes the “name” and “salary” instance variables and the “set_salary” method. The values associated with the “name” and “salary” variables in each employee object instance contain the name and salary of an employee in the organization. A message can be sent to an employee's employee object instance to invoke the “set_salary” method to modify the employee's salary (i.e., the value associated with the “salary” variable in the employee's employee object).

An object is a generic term that is used in the object-oriented programming environment to refer to a module that contains related code and variables. A software application can be written using an object-oriented programming language whereby the program's functionality is implemented using objects. Examples of object-oriented programming languages include C++ as well as Java.

Furthermore the invention may be practiced with other computer system configurations including hand-held devices, microprocessor systems, microprocessor-based or programmable consumer electronics, minicomputers, mainframe computers and the like. The invention may also be practiced in distributing computing environments where tasks are performed by remote processing devices that are linked through a network.

With the above embodiments in mind, it should be understood that the invention may employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations described herein that form part of the invention are useful machine operations. The invention also relates to a device or an apparatus for performing these operations. The apparatus may be specially constructed for the required purposes, such as the TCU discussed above, or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Although specific examples were provided with respect to automobiles, it will be understood that the embodiments are applicable to any object that can move about and process computer operations. For instance, application is envisioned, but not limited to automobiles, boats, planes, balloons, spacecraft, man powered transpiration, solar powered vehicles, etc.

The invention can also be embodied as computer readable code on a computer readable medium. The computer readable medium is any data storage device that can store data which can be thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A computer program embodied on a computer readable medium for abstracting physical devices in a system, comprising:
a physical device code segment capable receiving device data from a physical device;
a logical device code segment in communication with the physical device code segment, the logical device code segment capable of receiving the device data from the physical device code segment; and
an application code segment in communication with the logical device code segment, the application code segment capable of accessing the device data from the logical device code segment, the application code segment further capable of processing device data generated by the physical device.

2. A computer program as recited in claim 1, wherein the logical device code segment is capable of providing access to device data from a plurality of physical devices.

3. A computer program as recited in claim 2, wherein the plurality of physical devices provide data for the same number of variables.

4. A computer program as recited in claim 3, wherein the number of variables is one.

5. A computer program as recited in claim 4, wherein the physical control is a slider control.

6. A computer program as recited in claim 4, wherein the physical control is a dial control.

7. A computer program as recited in claim 3, wherein the number of variables is two.

8. A computer program as recited in claim 7, wherein the physical control is a mouse control.

9. A computer program as recited in claim 7, wherein the physical control is a trackball.

10. A method for abstracting physical devices in a system, comprising the operations of:
receiving device data from a physical device computer code segment, the physical device computer code segment capable receiving the device data from the physical device;
providing an access to the device data to an application program.

11. A method as recited in claim 10, wherein the device data includes a current state of the physical device.

12. A method as recited in claim 11, wherein the device data includes event data indicating whether the current state of the physical device has changed.

13. A method as recited in claim 10, wherein access to the device data is provided using an application programming interface (API).

14. A method as recited in claim 11, wherein the API provides access to device data from a plurality of physical devices, wherein the plurality of physical devices provide data for the same number of variables.

15. A computer interface for abstracting physical devices in a system, comprising:
a physical device implementation code segment capable receiving device data from a physical device; and
an application programming interface (API) code segment in communication with a physical device implementation code segment, the API code segment capable of receiving the device data from the physical device code segment,
wherein an application program can communicate with the API code segment to access the device data.

16. A computer interface as recited in claim 15, wherein the device data includes a current state of the physical device.

17. A computer interface as recited in claim 16, wherein the device data includes event data indicating whether the current state of the physical device has changed.

18. A computer interface as recited in claim 17, wherein the API code segment provides access to device data from a plurality of physical devices, wherein each physical device of the plurality of physical devices provides data for the same number of variables.

19. A computer interface as recited in claim 18, wherein the application program can access device data from different physical devices without altering the application program, each physical device providing data for the same number of variables.

20. A computer interface as recited in claim 19, wherein the physical devices are physical control devices for one of automobiles, boats, planes, balloons, spacecraft, man powered transpiration vehicles, and solar powered vehicles.
